(19) United States
(12) Patent Application Publication
(10) Pub. No.: US 2022/0078221 A1
(43) Pub. Date: Mar. 10, 2022

(54) INTERACTIVE METHOD AND APPARATUS FOR MULTIMEDIA SERVICE

(71) Applicant: BEIJING DAJIA INTERNET INFORMATION TECHNOLOGY CO., LTD., Beijing (CN)

(72) Inventor: Xiaobo ZHANG, Beijing (CN)

(21) Appl. No.: 17/465,522

(22) Filed: Sep. 2, 2021

(30) Foreign Application Priority Data
Sep. 4, 2020 (CN) 202010920561.9

(51) Int. Cl. H04L 29/06; H04L 29/08

(52) U.S. Cl. CPC H04L 65/60; H04L 67/26

(57) ABSTRACT

The present disclosure relates to Internet technologies and in particular to an interactive method and apparatus for a multimedia service. The method is as follows. An audience client records a selected candidate multimedia service and an associated client identification in an interaction list upon accessing a live broadcast room. In response to a host client selecting a target multimedia service and a target client identification based on the interaction list, at least one audience client corresponding to the target client identification accesses, based on a service identification and a service access address of the target multimedia service, an operation interface of the target multimedia service from the live broadcast room to interact with the host client.

### CROSS-REFERENCE TO RELATED APPLICATION

The present application claims the priority to the Chinese Patent Application No. 202010920561.9, titled “INTERACTIVE METHOD AND APPARATUS FOR MULTIMEDIA SERVICE,” filed on Sep. 4, 2020, the entire content of which is hereby incorporated by reference in its entirety.

### TECHNICAL FIELD

The present disclosure relates to Internet technologies and in particular to an interactive method and apparatus for a multimedia service.

### BACKGROUND

With the development of science and technologies, the application of live broadcast on smart terminals has become more and more extensive, and has gradually developed into a more mature technology. On the other hand, the technical foundation of various multimedia services is gradually mature. The multimedia services can be embedded in Web pages for use by users, and carry more complex operating experience, such as real-time interactive experience.

With the further improvement of user needs, at the present stage, it is often necessary to embed multimedia services during the live broadcast. With the existing technologies, the following methods are used.

A user logs in a live broadcast application (APP) and a multimedia service APP respectively on a smart terminal, then clicks a “project screen” button in an operation interface of the multimedia service APP, and selects, in a presentation interface of screen projection objects, the live broadcast APP on the same network as a screen projection object. Thus, the operation interface of the multimedia service is embedded in a live broadcast interface of a live broadcast room.

### SUMMARY

According to some arrangements, a live broadcast method for a multimedia service includes in response to access to a live broadcast room, obtaining a multimedia service list pushed in the live broadcast room. The multimedia service list at least records a service identification and a service access address of an interactive multimedia service. An interaction list recorded in the live broadcast room is obtained. The interaction list records candidate multimedia services and associated client identifications selected respectively by individual audience clients accessing the live broadcast room based on the multimedia service list. The method further includes selecting, based on the interaction list, one candidate multimedia service and at least one associated client identification as a target multimedia service and a target client identification, respectively, so that at least one audience client corresponding to the target client identification accesses an operation interface of the target multimedia service from the live broadcast room based on a service identification and a service access address of the target multimedia service. The method further includes accessing, based on the service identification and the service access address of the target multimedia service, the operation interface of the target multimedia service from the live broadcast room to interact with the at least one audience client.

According to some arrangements, a live broadcast method for a multimedia service includes in response to access to the live broadcast room, obtaining a multimedia service list pushed in a live broadcast room. The multimedia service list at least records a service identification and a service access address of an interactive multimedia service. The method further includes recording, in an interaction list pushed by the live broadcast room, a candidate multimedia service and an associated client identification selected based on the multimedia service list, and in response to a host client selecting the candidate multimedia service and the associated client identification as the target multimedia service and the target client identification, accessing, based on a service identification and a service access address of the target multimedia service, an operation interface of the target multimedia service from the live broadcast room. The method further includes in response to the host client accessing the operation interface of the target multimedia service from the live broadcast room, interacting with the host client in the operation interface.

According to some arrangements, a live broadcast method for a multimedia service includes in response to creating the live broadcast room, pushing a multimedia service list in a live broadcast room. The multimedia service list at least records a service identification and a service access address of an interactive multimedia service. The method further includes generating and presenting an interaction list to a host client according to feedbacks from individual audience clients accessing the live broadcast room. The interaction list records candidate multimedia services and associated client identifications selected respectively by the individual audience clients based on the multimedia service list. The method further includes determining, based on an instruction from the host client, one candidate multimedia service and at least one associated client identification as a target multimedia service and a target client identification, respectively, and enabling, based on a service identification and a service access address of the target multimedia service, the host client and at least one audience client corresponding to the target client identification access an operation interface of the target multimedia service from the live broadcast room, so that the host client interacts with the at least one audience client in the operation interface.

### BRIEF DESCRIPTION OF THE DRAWINGS

FIG. 1 is a schematic architecture diagram of a live broadcast system in some arrangements of the present disclosure;

FIG. 2 is a schematic flowchart diagram for a live broadcast server enabling a multimedia service live broadcast interaction function in some arrangements of the present disclosure;

FIG. 3A is a schematic flowchart diagram of an interaction process between a host client and an audience client in an operation interface of a selected target multimedia service in some arrangements of the present disclosure;

FIG. 3B is a schematic diagram of an interaction list in some arrangements of the present disclosure;

FIG. 4A is a schematic diagram of a live broadcast server pushing in real time to other audience clients a video data stream for an operation interface of a target multimedia service in some arrangements of the present disclosure;

FIG. 4B is a schematic diagram of an audience client X playing a game operation interface pushed by a live broadcast room in some arrangements of the present disclosure;

FIG. 4C is a schematic diagram of an audience client X playing a game operation interface pushed by a live broadcast room after view switching in some arrangements of the present disclosure;

FIG. 5A is a schematic diagram of an audience client 1 exiting a game operation interface in some arrangements of the present disclosure;

FIG. 5B is a schematic diagram of an updated interaction list in some arrangements of the present disclosure;

FIG. 5C is a schematic diagram of an audience client X accessing a game operation interface from a live broadcast room in some arrangements of the present disclosure;

FIG. 6 is a schematic logical architecture diagram of a host client in some arrangements of the present disclosure;

FIG. 7 is a schematic logical architecture diagram of an audience client in some arrangements of the present disclosure;

FIG. 8 is a schematic logical architecture diagram of a live broadcast server in some arrangements of the present disclosure;

FIG. 9 is a schematic physical architecture diagram of a computer device in some arrangements of the present disclosure; and

FIG. 10 is a schematic physical architecture diagram of a network device in some arrangements of the present disclosure.

### DETAILED DESCRIPTION OF THE ARRANGEMENTS

In order to improve correlation between multiple services and enhance interactivity between participants, in arrangements of the present disclosure, a live broadcast service and a multimedia service are interactively combined, so that more rich interactive experience is provided for a host client and an audience client.

Arrangements of the present disclosure will be described in detail below with reference to the accompanying drawings.

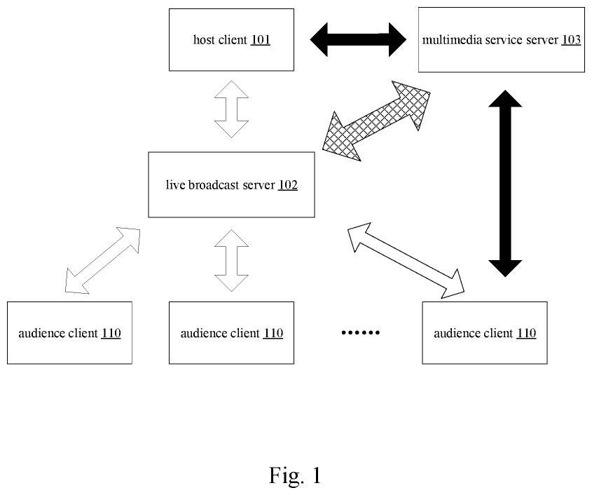

As shown in FIG. 1, in arrangements of the present disclosure, the host client 101 can log into a live broadcast server 102 and a multimedia service server 103 respectively, and the audience clients 110 (and individually, audience client 110) can also log into the live broadcast server 102 and the multimedia service server 103 respectively. In addition, a live broadcast cloud push stream service can be established between the live broadcast server 102 and the multimedia service server 103, so that the live broadcast server 102 can obtain a desired multimedia service stream from the multimedia service server 103.

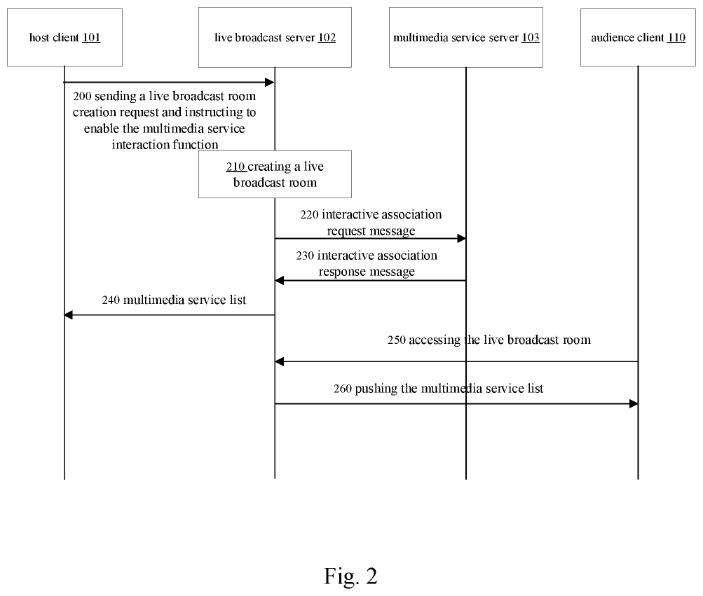

Based on the above system architecture, and referring to FIG. 2, in arrangements of the present disclosure, a specific process in which the live broadcast server 102 enables a multimedia service live broadcast function is as follows.

At 200, the host client 101 sends a live broadcast room creation request to the live broadcast server 102, and instructs to enable the multimedia service live broadcast function.

In arrangements of the present disclosure, the multimedia service server 103 can provide multiple types of multimedia services, which can be flexibly configured according to different application scenarios.

In some arrangements, in a case where the multimedia service server 103 is a cloud game center, the provided multimedia service may be a cloud game.

In other arrangements, in a case where the multimedia service server 103 is an e-commerce platform, the provided multimedia service may be a product sales service.

No more examples are given here. In subsequent arrangements of the present disclosure, the multimedia service server 103 being the cloud game center is taken as an example.

On the other hand, the host client 101 can carry a service type identification of the multimedia service in the live broadcast room creation request. In response to determining that the received live broadcast room creation request carries the service type identification, the live broadcast server 102 determines that the multimedia service corresponding to the service type identification needs to be live broadcasted on the live broadcast server 102.

At 210, the live broadcast server 102 creates a live broadcast room.

At 220, the live broadcast server 102 sends an interactive association request message to the multimedia service server 103 (e.g., the multimedia service platform).

In some arrangements, the live broadcast server 102 may determine, according to the service type identification, the interactive association request message is sent to which multimedia service platform.

At 230, the multimedia service server 103 returns an interactive association response message to the live broadcast server 102, wherein the interactive association response message carries a multimedia service list.

In some arrangements, not all the multimedia services on the multimedia service server 103 support the interaction function. Therefore, the multimedia service server 103 generates the multimedia service list based on the multimedia services that support the interaction function, and returns the multimedia service list to the live broadcast server 102. In the multimedia service list, service description information of each multimedia service is included, and one piece of service description information at least records a service identification (i.e., service ID) and a service access address of one multimedia service, and it may also contain service basic information, such as service name, introduction information, cover, service developer list, the number of candidate participant clients, and so on.

At 240, the live broadcast server 102 sends the multimedia service list to the host client 101.

In some arrangements, after receiving the multimedia service list pushed in the live broadcast room, the host client 101 presents the multimedia service list to the host.

In some arrangements, after the step 240 is performed, and before the step 250 is performed, that is, before the audience client 110 accesses the live broadcast room, the host client 101 can update content in the multimedia service list according to the host's instruction, such as, adding a new multimedia service, deleting an existing multimedia service, and so on.

In this way, the host can flexibly update the multimedia service list according to his/her own preferences or other service needs.

At 250, the audience client 110 accesses the live broadcast room.

For ease of description, in arrangements of the present disclosure, FIG. 2 only uses one audience client 110 as an example for description.

At 260, the live broadcast server 102 pushes the multimedia service list to the audience client 110.

In some arrangements, in a case where the host client 101 does not update the multimedia service list, the live broadcast server 102 pushes the original multimedia service list to the audience client 110; and in a case where the host client 101 has updated the multimedia service list, the live broadcast server 102 pushes the updated multimedia service list to the audience client 110, which is not repeated here.

In this way, once the host client 101 creates the live broadcast room on the live broadcast server 102 and enables the multimedia service live broadcast function, all the audience clients 110 accessing the live broadcast room can obtain the multimedia service list, thus obtaining the service identification and the service access address of each multimedia service, and also obtaining the number of the candidate participant clients.

In some arrangements, in a case where a certain multimedia service in the multimedia service list is “Network Game: Chinese Poker”, detailed service description information of “Chinese Poker” may be recorded in the multimedia service list. The service description information at least contains a service access address of “Chinese Poker”, and may also include a service ID, game introduction, cover picture, author, the number of the participants, etc. of “Chinese Poker”.

In practical applications, even if it is the same type of multimedia service, multiple tasks can be run in different areas on the multimedia service server 103, respectively. For the game “Chinese Poker”, different hosts can create different game rooms on the multimedia service server 103, so as to attract different audience clients 110 to switch from different live broadcast rooms on the live broadcast server 102 to the corresponding game rooms on the multimedia service server 103.

Therefore, in order to effectively guide the audience clients 110, the multimedia service list has to record the detailed service description information of each multimedia service, and the service description information carries the service access address to distinguish among different game rooms.

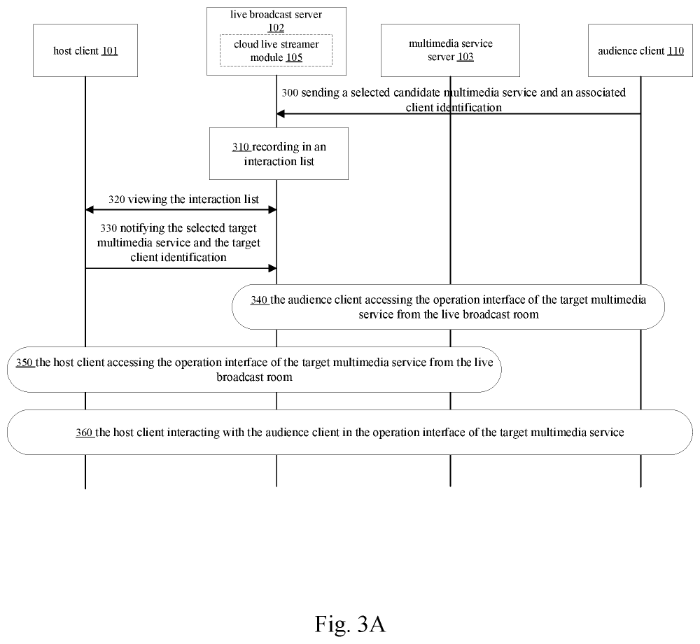

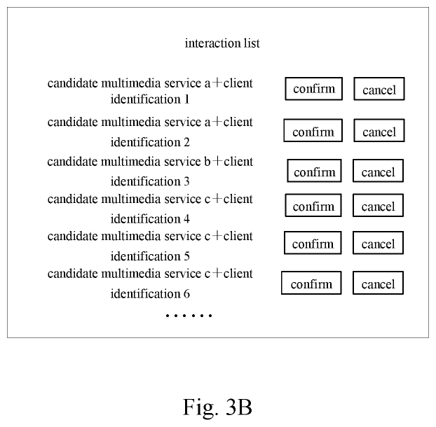

Further, after completing the above preparation process, the audience client 110 can start to select a candidate multimedia service, and the host client 101 can select the final target multimedia service from various candidate multimedia services, so as to interact with the audience client 110 in an operation interface of the target multimedia service. Referring to FIG. 3A, a specific process is as follows. The live broadcast server 102 includes a cloud live streamer module 105.

At 300, the audience client 110 sends the selected candidate multimedia service and an associated client identification to the live broadcast server 102.

In some arrangements, after obtaining the pushed multimedia service list in the live broadcast room, the audience client 110 may present the multimedia service list to the corresponding audience, select a candidate multimedia service based on the audience's instruction, and associate the candidate multimedia service with the client identification of the audience client 110 and send it to the live broadcast server 102 for recording.

At 310, the live broadcast server 102 records the candidate multimedia service selected by the audience client 110 and the associated client identification in the interaction list.

In arrangements of the present disclosure, referring to FIG. 3B, the interaction list is stored on the live broadcast server 102, which is used to record the candidate multimedia services and associated client identifications selected by individual audience clients 110 accessing the live broadcast room. The interaction list can be viewed by the host client 101 and individual audience clients 110 at any time, and any audience client 110 can decide to select which candidate multimedia service based on the candidate multimedia services selected by other audience clients 110.

With respect to 300, only a single audience client 110 is taken as an example, and it is assumed that when the single audience client 110 selects the candidate multimedia service, no other information is recorded in the interaction list.

At 320, the host client 101 views the interaction list in the live broadcast room.

At 330, the host client 101 notifies the live broadcast server 102 of the selected target multimedia service and the target client identification.

In some arrangements, referring to FIG. 3B, different audience clients 110 may select the same candidate multimedia service. In this case, the host client 101 needs to decide to select which one of the candidate multimedia services as the target multimedia service, then obtains, according to the service description information recorded in the multimedia service list, the number of the candidate participant clients which is set in correspondence with the target multimedia service, and selects, according to the number of the candidate participant clients, at least one client identification as the target client identification from individual client identifications associated with the target multimedia service. As shown in FIG. 3B, the host client 101 only needs to click the “OK” button in the interaction list to select the target multimedia service and the associated target client identification.

In this way, the number of the audience clients 110 that access the operation interface of the target multimedia service can be controlled according to the number of the candidate participant clients, so as to prevent the influx of too many audience clients 110 thus causing confusion in the interactive effect.

In some arrangements, as shown in FIG. 3B, in a case where the host client 101 selects the candidate multimedia service a as the target multimedia service, the number of the candidate participant clients which is set in correspondence with the candidate multimedia service a is 2, and the host client 101 only clicks a “Confirmation” button associated with the client identification 2, then the final confirmed target multimedia service is the candidate multimedia service a, and the final confirmed target client identification is the client identification 2.

At 340, the audience client 110 accesses the operation interface of the target multimedia service from the live broadcast room.

In some arrangements, the audience client 110 uses the service identification and the service access address of the target multimedia service provided in the multimedia list to log into the corresponding multimedia service server 103, and access the operation interface of the target multimedia service.

In some arrangements, the target multimedia service selected by the host client 101 is “Network Game: Minesweeper”, and one client identification is selected as the target client identification. In this case, the audience client 110 corresponding to the one client identification can switch to the cloud game center (CGC) from the live broadcast server 102 according to the service access address provided corresponding to “Network Game: Minesweeper” in the multimedia service list, and then enter the newly created game room corresponding to the service access address. In this way, the audience client 110 can interact with the host client 101 in the game room on the cloud game center.

At 350, the host client 101 accesses the operation interface of the target multimedia service from the live broadcast room.

In some arrangements, the host audience client 110 can also use the service identification and the service access address of the target multimedia service provided in the multimedia list, log into the corresponding multimedia service server 103, and access the operation interface of the target multimedia service.

In arrangements of the present disclosure, there is no strict execution sequence between the step 340 and the step 350.

At 360, the host client 101 interacts with the audience client 110 in the operation interface of the target multimedia service.

In some arrangements, the host client 101 and the audience client 110 can complete the game in an interactive manner in the operation interface of “Network Game: Minesweeper” in the cloud game center.

In this way, the audience client 110 can seamlessly switch to the operation interface of the target multimedia service in the live broadcast room without a separate login, thus saving the operation time and realizing service integration.

On the other hand, in the above arrangement, in a case where other information has been recorded in the interaction list before the audience client 110 selects the candidate multimedia service in the step 300, the audience client 110 can perform operations as follows: obtaining the recorded information in the interaction list, wherein the recorded information contains other candidate multimedia services and other associated client identifications selected respectively by other audience clients 110 that access the live broadcast room based on the multimedia service list; presenting the recorded information to the audience; and notifying, according to a received instruction, the live broadcast server 102 to record the selected candidate multimedia service and the associated client identifier in the interaction list.

In this way, the audience client 110 can refer to the candidate multimedia services selected by other audience clients 110 to select its favorite candidate multimedia service. Thus, complicated operations can be avoided effectively such as exiting and re-selecting after a wrong selection, thus improving convenience.

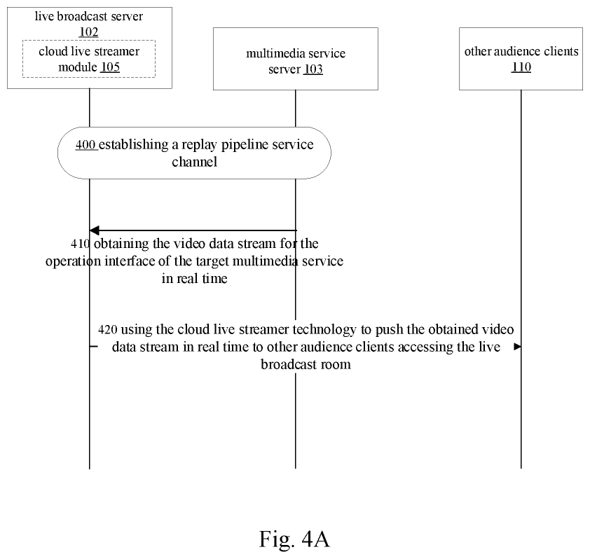

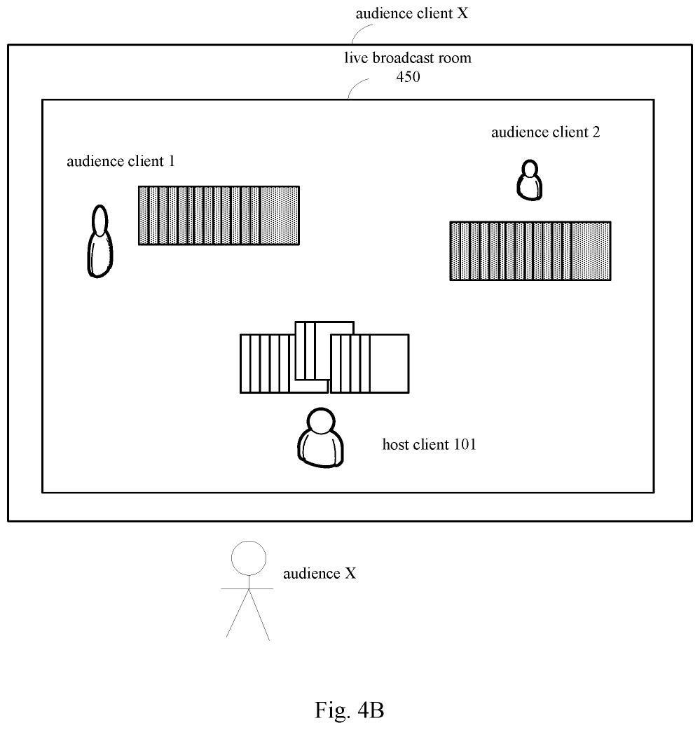

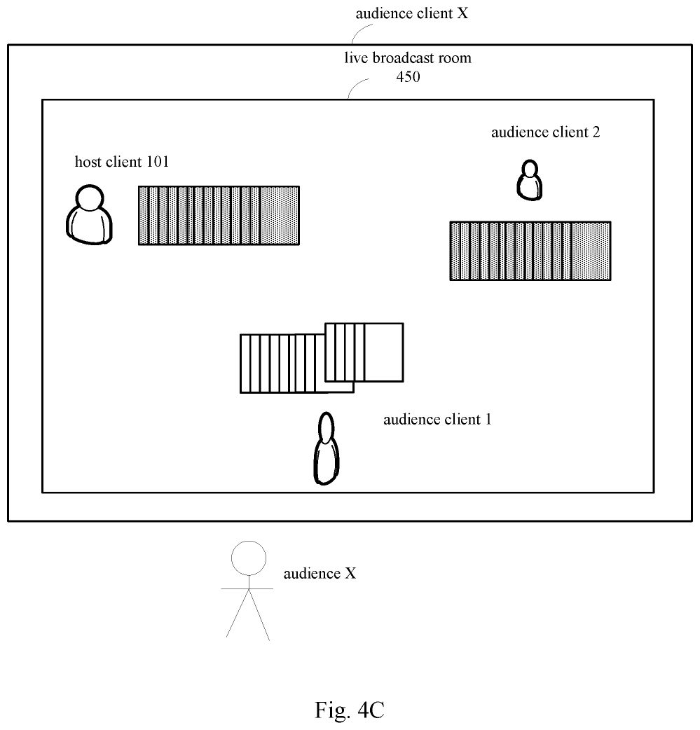

Based on the above arrangements, the host client 101 and the audience client 110 interact in the operation interface of the target multimedia service. The live broadcast server 102 can live broadcast the operation interface in the live broadcast room. Referring to FIG. 4A, a specific process is as follows.

At 400, a replay pipeline service (RPS) is established by the live broadcast server 102 between the live broadcast server 102 and the multimedia service server 103.

In arrangements of the present disclosure, referring to FIG. 4A, the replay pipeline service can be established by the live broadcast server 102 between the live broadcast server 102 and the multimedia service server 103, so that the live broadcast server 102 and the multimedia service server 103 are interconnected.

At 410, the multimedia service server 103 obtains the video data stream for the operation interface of the target multimedia service in real time, and transmits it back to the live broadcast server 102 through the replay pipeline service.

In arrangements of the present disclosure, referring to FIG. 4A, a cloud live streamer (CLS) module 105 is provided in the live broadcast server 102. The live broadcast server 102 can obtain, based on the established replay pipeline service, the video data stream for the operation interface of the target multimedia service in real time from the multimedia service server 103, and perform live broadcast in the live broadcast room through the cloud live streamer module 105. The video data stream contains the interaction content between the host client 101 and the audience client 110 in the operation interface of the target multimedia service.

In other words, the multimedia service server 103 transmits the video data stream for the operation interface of the target multimedia service to the cloud live streamer module 105 in real time through the established replay pipeline service, and the cloud live streamer module 105 pushes the above video data stream to the live broadcast room for live broadcast. Thus, all the other audience clients 110 accessing the live broadcast room can watch the interaction content in real time.

At 420, in the live broadcast room established by the host client 101, the live broadcast server 102 uses the cloud live streamer technology to push the obtained video data stream in real time to other audience clients 110 accessing the live broadcast room.

In some arrangements, taking “Network Game: Chinese Poker” as an example, and as shown in FIG. 4B, in a case where the host client 101, the audience client 1(110) and the audience client 2(110) switch from the live broadcast server 102 to the operation interface of “Chinese Poker” on the cloud game center, and perform the game interaction in the operation interface, the audience X(110) accesses the live broadcast room 450 through the audience client X. At this time, the live broadcast server 102 will use a replay management service to capture the operation interface of “Chinese Poker” and play it in the live broadcast room 450. The audience X can watch the whole process of game interaction between the host client 101, the audience client 1 and the audience client 2 in the operation interface of “Chinese Poker” in real time on the audience client X.

Further, under normal circumstances, when the live broadcast server 102 pushes the video data stream for the operation interface of the target multimedia service to individual audience clients 110, the video data stream in the viewing angle of the host client 101 is pushed by default. Each audience watching the live broadcast can choose to switch between different viewing angles based on their own preference, and send a video data stream switching request to the live broadcast server 102 through the audience client 110. The video data stream switching request carries identification information of a target object. Then, the live broadcast server 102 may adjust, based on the identification information of the target object, the video data stream according to the viewing angle of the target object. Thus, the live broadcast server 102 can separately push the video data stream that meets the audience's preference for different audience clients 110, thus effectively expanding service flexibility and richness.

In some arrangements, still taking “Network Game: Chinese Poker” as an example, and referring to FIGS. 4B and 4C, in a case where the audience X wants to switch the live broadcast screen from the viewing angle of the host client 101 to the viewing angle of the audience client 1, the audience X sends a video data stream switching request carrying the identification information of the audience client 1 to the live broadcast server 102 through the audience client X. After receiving the video data stream switching request, the live broadcast server 102 re-pushes the video data stream corresponding to the identification information of the audience client 1 (that is, a video data stream corresponding to the viewing angle of the audience client A) to the audience client X.

Furthermore, based on the above arrangements, other audiences may watch, on other audience clients 110 used by themselves, the video data stream for the operation interface of the target multimedia service pushed in real time in the live broadcast room 450. In this case, if they are interested in the target multimedia service, they can also request to access the above operation interface, and interact with the host client 101 and the accessing audience clients 110. Specific operations are as follows.

Another audience client 110 can update the interaction list stored in the live broadcast room 450, that is, request the live broadcast server 102 to record the target multimedia service and its associated client identification in the interaction list, for requesting to access the operation interface of the target multimedia service.

The live broadcast server 102 may push the updated interaction list to the host client 101 through the live broadcast room 450. At this time, although the host client 101 is currently interacting with the accessing audience clients 110 in the operation interface of the target multimedia service, the updated interaction list sent by the live broadcast room 450 can be received through the background interface.

In a case where the number of the audience clients 110 currently accessing the operation interface does not reach the corresponding number of the candidate participant clients, the host client 101 allows the other audience clients 110 to access the operation interface of the target multimedia service from the live broadcast room 450, so as to interact with the host client 101 and the accessing audience clients 110.

In this way, other clients that have not accessed the operation interface of the target multimedia service for the first time can request for access to the operation interface again at a later stage, so as to interact with the host client 101, thus increasing the flexibility of the interaction method and being suitable for a wider range of application scenes.

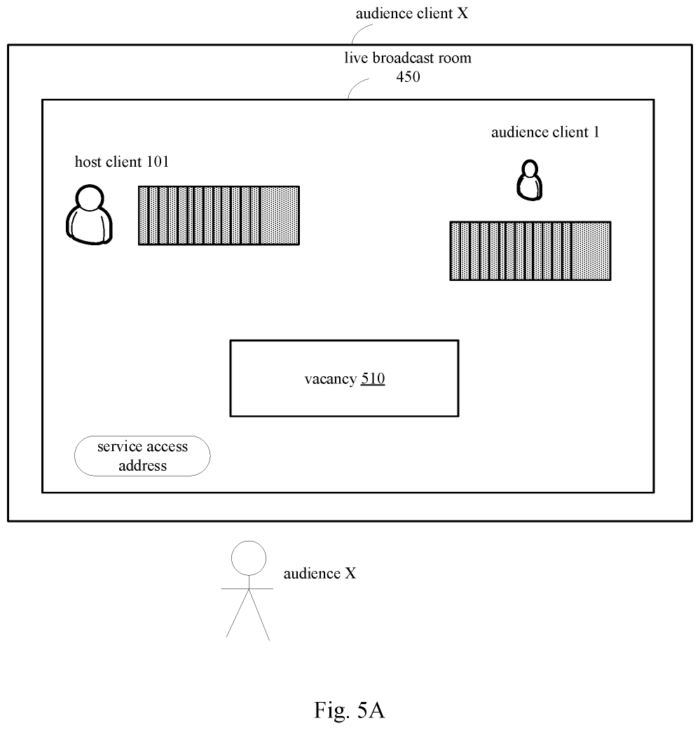

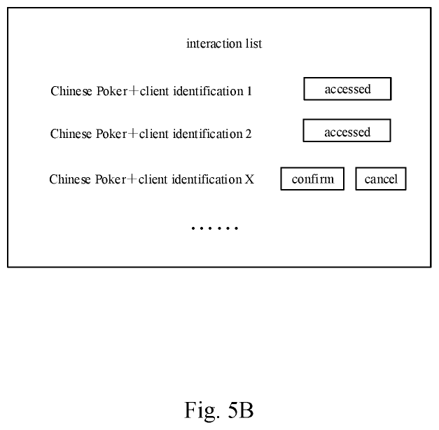

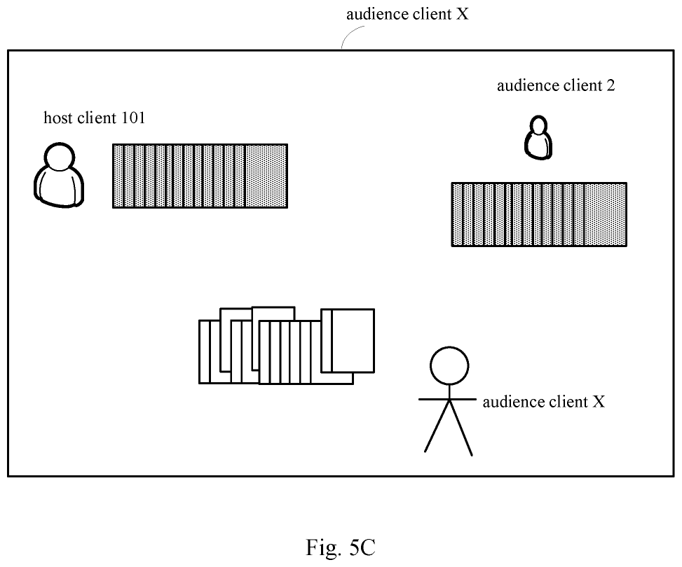

In some arrangements, still taking “Network Game: Chinese Poker” as an example, and referring to FIG. 5A, the audience X considers that the network game “Chinese Poker” is interesting after watching for a period of time, and at this time, the audience client 1 exits the cloud game center, leaving a vacancy 510 in the game. Then, the audience X records “Chinese Poker+client identification X” in the interaction list through the audience client X, as shown in FIG. 5B. The live broadcast server 102 may push the updated interaction list from background to the host client 101. The host client 101 confirms that only the audience client 2 is left in the operation interface of the current game, leaving a vacancy 510, and clicks the “OK” button. The live broadcast server 102 will switch the audience client X from the live broadcast room 450 to the cloud game center to enter the operation interface of “Chinese Poker”. As shown in FIG. 5C, after accessing, the audience client X can continue the game interaction with the host client 101 and the audience client 2 in the operation interface of “Chinese Poker”.

In arrangements of the present disclosure, in a case where the audience client 110 uses the same user ID and login password on the live broadcast server 102 and the multimedia service server 103, the live broadcast server 102 can notify the multimedia service server 103 of the user ID and login password while the audience client 110 is switching from the live broadcast server 102 to the multimedia service server 103. Thus, the automatic login of the audience client 110 can be completed.

In a case where the audience client 110 uses different user IDs and login passwords on the live broadcast server 102 and the multimedia service server 103, the multimedia service server 103 may notify the audience client 110 to re-enter the corresponding user ID and login password while the audience client 110 is switching from the live broadcast server 102 to the multimedia service server 103. As long as the new user ID and login password are obtained, the manual login of the audience client 110 is completed.

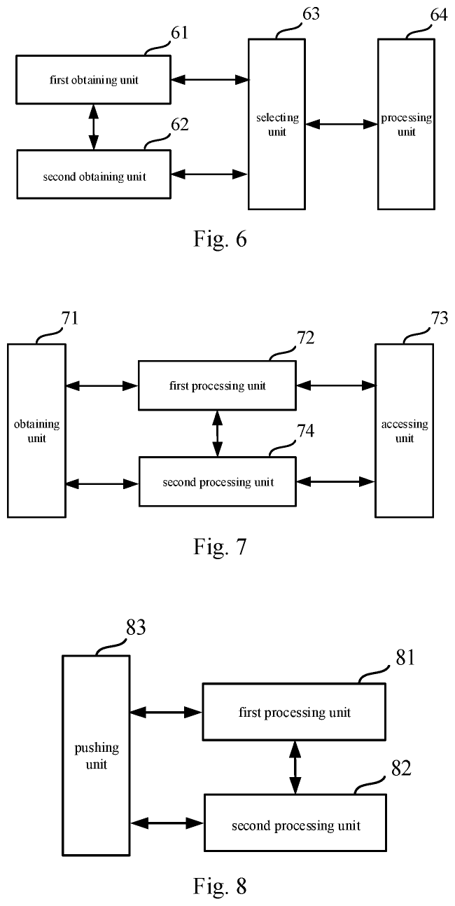

Referring to FIG. 6, arrangements of the present disclosure provide a computer device (such as, a host client 101), which at least include a first obtaining unit 61, a second obtaining unit 62, a selecting unit 63, and a processing unit 64.

The first obtaining unit 61 is configured to obtain a multimedia service list pushed in a live broadcast room in response to access to the live broadcast room, wherein the multimedia service list at least records a service identification and a service access address of an interactive multimedia service.

The second obtaining unit 62 is configured to obtain an interaction list recorded in the live broadcast room, wherein the interaction list records candidate multimedia services and associated client identifications selected respectively by individual audience clients 110 accessing the live broadcast room based on the multimedia service list.

The selecting unit 63 is configured to select, based on the interaction list, one candidate multimedia service and at least one associated client identification as a target multimedia service and a target client identification, respectively, so that at least one audience client 110 corresponding to the target client identification accesses an operation interface of the target multimedia service from the live broadcast room based on a service identification and a service access address of the target multimedia service.

The processing unit 64 is configured to access, based on the service identification and the service access address of the target multimedia service, the operation interface of the target multimedia service from the live broadcast room to interact with the at least one audience client 110.

In an arrangement, after the multimedia service list pushed in the live broadcast room is obtained, and before the interaction list recorded in the live broadcast room is obtained, the first obtaining unit 61 is further configured to: present the multimedia service list and updating the multimedia service list based on a received instruction.

In an arrangement, with respect to selecting, based on the interaction list, one candidate multimedia service and at least one associated client identification as the target multimedia service and the target client identification respectively, the selecting unit 63 is configured to: select, based on the interaction list, one candidate multimedia service as the target multimedia service; obtain, based on the multimedia service list, the number of the candidate participant clients which is set in correspondence with the target multimedia service; and select, according to the number of the candidate participant clients, at least one client identification as the target client identification from individual client identifications associated with the target multimedia service.

In an arrangement, after interacting with the at least one audience client 110, the processing unit 64 is further configured to: receive an updated interaction list pushed in background, wherein the updated interaction list records a new client identification that requests to access the target multimedia service; and allow an audience client 110 corresponding to the new client identification to switch from the live broadcast room to the operation interface of the target multimedia service in response to determining that the number of the currently interactive audience clients 110 has not reached the number of the candidate participant clients.

Referring to FIG. 7, arrangements of the present disclosure provide a computer device (such as an audience client), which at least include an obtaining unit 71, a first processing unit 72, an accessing unit 73, and a second processing unit 74.

The obtaining unit 71 is configured to obtain a multimedia service list pushed in a live broadcast room in response to access to the live broadcast room, wherein the multimedia service list at least records a service identification and a service access address of an interactive multimedia service.

The first processing unit 72 is configured to record, in an interaction list pushed by the live broadcast room, a candidate multimedia service and an associated client identification selected based on the multimedia service list.

The accessing unit 73 is configured to access an operation interface of the target multimedia service from the live broadcast room based on a service identification and a service access address of the target multimedia service, in response to a host client 101 selecting the candidate multimedia service and the associated client identification as the target multimedia service and the target client identification.

The second processing unit 74 is configured to interact with the host client 101 in the operation interface in response to the host client 101 accessing the operation interface of the target multimedia service from the live broadcast room.

In some arrangements, with respect to recording, in the interaction list pushed by the live broadcast room, the candidate multimedia service and the associated client information selected based on the multimedia service list, the first processing unit 72 is configured to: obtain recorded information in the interaction list, wherein the recorded information contains other candidate multimedia services and other associated client identifications selected respectively by other audience clients 110 that access the live broadcast room based on the multimedia service list; and present the recorded information, and recording a selected candidate multimedia service and an associated client identification in the interaction list according to a received instruction.

In some arrangements, in response to the host client 101 not selecting the candidate multimedia service and the associated client identification as the target multimedia service and the target client identification, the second processing unit 74 is further configured to: obtain and play, in the live broadcast room, a video data stream for an operation interface of another target multimedia service pushed by the live broadcast room, wherein the video data stream contains an interaction content between the host client 101 and other audience clients 110 in the operation interface of the other target multimedia service, and the video data stream is obtained in real time through a replay pipeline service from a multimedia service server 103 carrying the other target multimedia service, and is pushed in real time in the live broadcast room by using a cloud live streamer technology.

In some arrangements, the first processing unit 72 is further configured to: record the other target multimedia service and the associated client identification in the interaction list, for requesting to access the operation interface of the other target multimedia service; and push an updated interaction list to the host client 101 through the live broadcast room.

The second processing unit 74 is further configured to: access the operation interface of the other target multimedia service from the live broadcast room to interact with the host client 101, in response to obtaining permission from the host client 101.

Referring to FIG. 8, arrangements of the present disclosure provide a network device (such as a live broadcast server 102), which at least include a first processing unit 81, a second processing unit 82, and a pushing unit 83.

The pushing unit 83 is configured to push a multimedia service list in a live broadcast room in response to creating the live broadcast room, wherein the multimedia service list at least records a service identification and a service access address of an interactive multimedia service.

The first processing unit 81 is configured to generate and present an interaction list to a host client 101 according to feedbacks from individual audience clients 110 accessing the live broadcast room, wherein the interaction list records candidate multimedia services and associated client identifications selected respectively by individual audience clients 110 based on the multimedia service list.

The second processing unit 82 is configured to determine, based on an instruction from the host client 101, one candidate multimedia service and at least one associated client identification as a target multimedia service and a target client identification, respectively, and enables, based on a service identification and a service access address of the target multimedia service, the host client 101 and at least one audience client 110 corresponding to the target client identification access an operation interface of the target multimedia service from the live broadcast room, so that the host client 101 interacts with the at least one audience client 110 in the operation interface.

In some arrangements, after enabling the host client 101 and the at least one audience client 110 corresponding to the target client identification access the operation interface of the target multimedia service from the live broadcast room, the first processing unit 81 is further configured to: obtain a video data stream for the operation interface of the target multimedia service in real time through a replay pipeline service from a multimedia service server 103 carrying the target multimedia service, wherein the video data stream contains the interaction content between the host client 101 and individual audience clients 110 in the operation interface of the target multimedia service; and push the video data stream in real time to other audience clients 110 that access the live broadcast room by using a cloud live streamer technology.

In an arrangement, after pushing the video data stream in real time to the audience clients 110 that access the live broadcast room, the first processing unit 81 is further configured to: receive a video data stream switching request sent by other audience clients 110, wherein the video data stream switching request carries identification information of a target object; and re-push, based on the identification information, a corresponding video data stream to the other audience clients 110 according to a viewing angle of the target object.

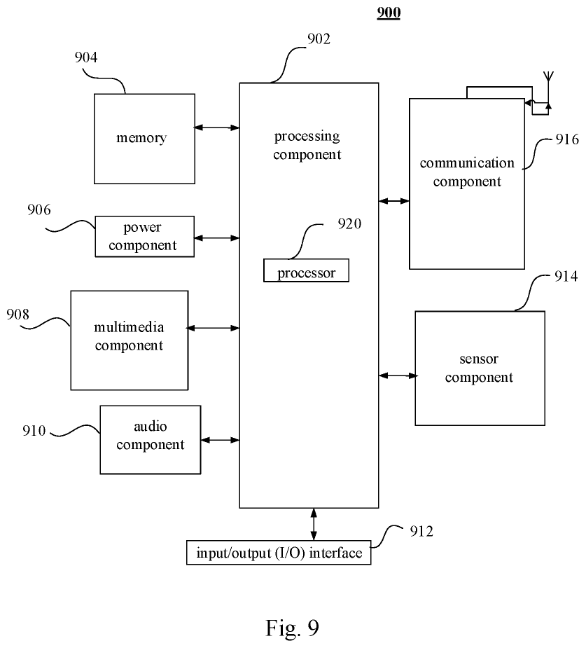

Referring to FIG. 9, arrangements of the present disclosure provide a computer device. For example, the electronic device 900 may be a mobile phone, a computer, a digital broadcast terminal, a messaging device, a game console, a tablet device, a medical device, a fitness device, a personal digital assistant, or the like.

Referring to FIG. 9, the electronic device 900 may include one or more of the following components: a processing component 902, a memory 904, a power component 906, a multimedia component 908, an audio component 910, an input/output (I/O) interface 912, a sensor component 914, and a communication component 916.

The processing component 902 typically controls the overall operation of the electronic device 900, such as the operation associated with display, telephone calls, data communications, camera operations, and recording operations. The processing component 902 can include one or more processors 920 to execute instructions, so as to perform all or part of the steps in the above described methods. Moreover, the processing component 902 can include one or more modules to facilitate the interaction between the processing component 902 and other components. For example, the processing component 902 can include a multimedia module to facilitate the interaction between the multimedia component 908 and the processing component 902.

The memory 904 is configured to store various types of data to support the operation of the electronic device 900. Examples of such data include instructions for any application or method operated on the electronic device 900, such as the contact data, the phone book data, messages, pictures, videos, and the like. The memory 904 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 906 provides power to various components of the electronic device 900. The power component 906 can include a power management system, one or more power sources, and other components associated with the generation, management, and distribution of power in the electronic device 900.

The multimedia component 908 includes a screen providing an output interface between the electronic device 900 and the user. In some arrangements, the screen can include a liquid crystal display (LCD) and a touch panel (TP). If the screen includes the touch panel, the screen can be implemented as a touch screen to receive input signals from the user. The touch panel includes one or more touch sensors to sense touches, swipes, and gestures on the touch panel. The touch sensors may not only sense a boundary of a touch or swipe action, but also sense a duration time and a pressure associated with the touch or swipe action. In some arrangements, the multimedia component 908 includes a front camera and/or a rear camera. When the electronic device 900 is in an operation mode, such as a photographing mode or a video mode, the front camera and/or the rear camera can receive external multimedia data. Each of the front camera and the rear camera may be a fixed optical lens system or have the capability of focusing and optical zooming.

The audio component 910 is configured to output and/or input an audio signal. For example, the audio component 910 includes a microphone (MIC), configured to receive an external audio signal when the electronic device 900 is in an operation mode, such as a call mode, a recording mode, and a voice recognition mode. The received audio signal may be further stored in the memory 904 or sent via the communication component 916. In some arrangements, the audio component 910 also includes a speaker for outputting the audio signal.

The I/O interface 912 provides an interface between the processing component 902 and peripheral interface modules, such as a keyboard, a click wheel, buttons, and the like. These buttons may include, but are not limited to, a home button, a volume button, a starting button, and a locking button.

The sensor component 914 includes one or more sensors for providing status assessments of various aspects of the electronic device 900. For example, the sensor component 914 can detect an open/closed status of the electronic device 900, relative positioning between components, such as the display and the keypad of the electronic device 900. The sensor component 914 can also detect a change in position of the electronic device 900 or one component of the electronic device 900, the presence or absence of user contact with the electronic device 900, an orientation or an acceleration/deceleration of the electronic device 900, and a change in temperature of the electronic device 900. The sensor component 914 can include a proximity sensor, configured to detect the presence of nearby objects without any physical contact. The sensor component 914 can also include a light sensor, such as a CMOS or CCD image sensor, configured to use in imaging applications. In some arrangements, the sensor component 914 can also include an accelerometer sensor, a gyroscope sensor, a magnetic sensor, a pressure sensor, or a temperature sensor.

The communication component 916 is configured to facilitate wired or wireless communication between the electronic device 900 and other devices. The electronic device 900 can access a wireless network based on a communication standard, such as WiFi, an Operator network (such as 2G; 3G; 4G or 5G), or a combination thereof. In an exemplary arrangement, the communication component 916 receives broadcast signals or broadcast associated information from an external broadcast management system via a broadcast channel. In an exemplary arrangement, the communication component 916 also includes a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In an exemplary arrangement, the electronic device 900 may be implemented by one or more application specific integrated circuits (ASICs), digital signal processors (DSPs), digital signal processing devices (DSPDs), programmable logic devices (PLDs), field programmable Gate array (FPGA), controller, microcontroller, microprocessor or other electronic components, and may be configured to perform any method of the aspects above.

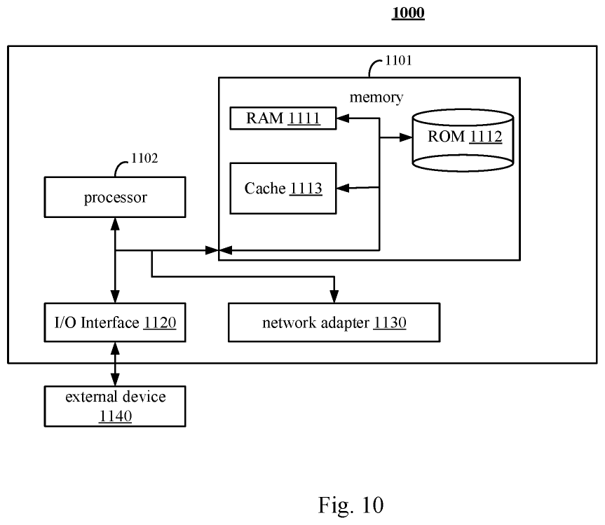

Referring to FIG. 10, arrangements of the present disclosure provide a network device 1000, including: a memory 1101 for storing executable instructions; and a processor 1102 configured to read and execute the executable instructions stored in the memory to perform any one of the methods in the aspect above. The processor 1102 typically controls the overall operation of the network device 1000, such as the operations associated with display, telephone calls, data communications, camera operations, and recording operations. The memory 1101 is configured to store various types of data to support the operation on the network device 1000. Examples of such data include instructions for any application or method operated on the network device 1000, such as the contact data, the phone book data, messages, pictures, videos, and the like. The memory 1101 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk. As shown, the memory 1101 includes a RAM 1111, a ROM 1112, and a cache 1113. The processor 1102 and memory 1101 are operatively coupled to an I/O interface 1120 and a network adapter 1130. The I/O interface 1120 is operatively coupled to an external device 1140.

Arrangements of the present disclosure provide a computer-readable storage medium, wherein instructions in the computer-readable storage medium, when executed by a processor, can execute any one of the methods in the above-mentioned arrangements.

Arrangements of the present disclosure provide a computer program product containing executable instructions. The executable instructions of the computer program product, when executed by a processor, can execute any one of the methods in the above-mentioned arrangements.

Arrangements of the present disclosure provide a computer-readable storage medium. Instructions in the storage medium, when executed by a processor, cause the processor to perform any one of the methods executed by the live broadcast server 102 in the above arrangements.

Arrangements of the present disclosure provide a computer-readable storage medium. Instructions in the storage medium, when executed by a processor, cause the processor to perform any one of the methods executed by the audience client 110 in the above arrangements.

In summary, in arrangements of the present disclosure, after accessing the live broadcast room, the audience client 110 records the selected candidate multimedia service and the associated client identification in the interaction list based on the multimedia service list pushed in the live broadcast room. In response to the host client 101 selecting the target multimedia service and the target client identification based on the interaction list, at least one audience client 110 corresponding to the target client identification accesses, based on the service identification and the service access address of the target multimedia service, the operation interface of the target multimedia service from the live broadcast room to interact with the host client 101. In this way, the audience client 110 can directly access the operation interface of the target multimedia service from the live broadcast room according to its own choice, and interact with the host client 101. Thus, the degree of association and integration between different services is greatly improved, and the interactivity between the participants is improved at the same time. Thus, a richer interactive experience is provided between the host client 101 and the audience client 110, which significantly improves the operating convenience of multimedia services, and is conducive to the further promotion and application of multimedia services.

Those skilled in the art should understand that, examples of arrangements of the present application may be embodied as a method, a system or a computer program product (such as an executable program code). Accordingly, the present application may take the form of an entirely hardware arrangement, an entirely software arrangement, or an arrangement combining software and hardware aspects. Moreover, the present application can take the form of a computer program product which is executed on one or more computer-usable storage medium (including but not limited to a magnetic disk storage, a CD-ROM optical memory) containing computer-usable program code.

The present application is described with reference to flowcharts and/or block diagrams of methods, devices (systems) and computer program products according to arrangements of the present application. It should be understood that, each flow and/or block of the flowcharts and/or block diagrams, and combinations of flowcharts and/or blocks in the flowcharts and/or block diagrams can be implemented by computer program instructions. These computer program instructions may be provided to a processor of a general purpose computer, a special purpose computer, an embedded processor, or other programmable data processing device to produce a machine, such that instructions, which are executed via the processor of the computer or other programmable data processing device, create means for implementing the functions specified in one or more flows in the flowchart and/or one or more blocks in the block diagram.

These computer program instructions may also be stored in a computer readable memory that can direct a computer or other programmable data processing device to function in a particular manner, such that the instructions stored in the computer readable memory produce an article of manufacture including instruction means which implement the functions specified in one or more flows in the flowchart and/or one or more blocks in the block diagram.

These computer program instructions may also be loaded onto a computer or other programmable data processing device, to cause a series of operational steps to be performed on the computer or other programmable device to produce treatment implemented by a computer, such that the instructions which are executed on the computer or other programmable device provide steps for implementing the functions specified in one or more flows in the flowchart and/or one or more blocks in the block diagram.

Although arrangements of the present application have been described, once those skilled in the art know basic creative concepts in the art, they can make additional alterations and modifications to these arrangements. Therefore, the appended claims are construed to include arrangements and all the alterations and modifications falling within the scope of the present application.

Evidently, those skilled in the art can make various modifications and variations to arrangements of the present disclosure without departing from the spirit and scope of arrangements of the present disclosure. Thus the disclosure is also intended to encompass these modifications and variations to the arrangements of the present disclosure as long as these modifications and variations come into the scope of the claims of the disclosure and their equivalents.

All the arrangements of the present disclosure can be executed individually or in combination with other arrangements, and they are all regarded as the scope of protection required by the present disclosure.

What is claimed is:

1. A live broadcast method for a multimedia service, comprising:
in response to access to a live broadcast room, obtaining a multimedia service list pushed in the live broadcast room, wherein the multimedia service list at least records a service identification and a service access address of an interactive multimedia service;
obtaining an interaction list recorded in the live broadcast room, wherein the interaction list records candidate multimedia services and associated client identifications selected respectively by individual audience clients accessing the live broadcast room based on the multimedia service list;
selecting, based on the interaction list, one candidate multimedia service and at least one associated client identification as a target multimedia service and a target client identification, respectively, so that at least one audience client corresponding to the target client identification accesses an operation interface of the target multimedia service from the live broadcast room based on a service identification and a service access address of the target multimedia service; and
accessing, based on the service identification and the service access address of the target multimedia service, the operation interface of the target multimedia service from the live broadcast room to interact with the at least one audience client.

2. The method according to claim 1, further comprising:
presenting the multimedia service list and updating the multimedia service list based on a received instruction.

3. The method according to claim 1, wherein the selecting, based on the interaction list, one candidate multimedia service and at least one associated client identification as the target multimedia service and the target client identification, respectively, comprises:
selecting, based on the interaction list, one candidate multimedia service as the target multimedia service;
obtaining, based on the multimedia service list, a number of candidate participant clients which is set in correspondence with the target multimedia service; and
selecting, according to the number of the candidate participant clients, at least one client identification as the target client identification from individual client identifications associated with the target multimedia service.

4. The method according to claim 2, wherein the selecting, based on the interaction list, one candidate multimedia service and at least one associated client identification as the target multimedia service and the target client identification, respectively, comprises:
selecting, based on the interaction list, one candidate multimedia service as the target multimedia service;
obtaining, based on the multimedia service list, a number of candidate participant clients which is set in correspondence with the target multimedia service; and
selecting, according to the number of the candidate participant clients, at least one client identification as the target client identification from individual client identifications associated with the target multimedia service.

5. The method according to claim 3, further comprising:
receiving an updated interaction list pushed in background, wherein the updated interaction list records a new client identification that requests to access the target multimedia service; and
in response to determining that a number of currently interactive audience clients has not reached the number of the candidate participant clients, allowing an audience client corresponding to the new client identification to switch from the live broadcast room to the operation interface of the target multimedia service.

6. A live broadcast method for a multimedia service, comprising:
in response to access to a live broadcast room, obtaining a multimedia service list pushed in the live broadcast room, wherein the multimedia service list at least records a service identification and a service access address of an interactive multimedia service;
recording, in an interaction list pushed by the live broadcast room, a candidate multimedia service and an associated client identification selected based on the multimedia service list;
in response to a host client selecting the candidate multimedia service and the associated client identification as a target multimedia service and a target client identification, accessing an operation interface of the target multimedia service from the live broadcast room based on a service identification and a service access address of the target multimedia service; and
in response to the host client accessing the operation interface of the target multimedia service from the live broadcast room, interacting with the host client in the operation interface.

7. The method according to claim 6, wherein the recording, in the interaction list pushed by the live broadcast room, the candidate multimedia service and the associated client identification selected based on the multimedia service list, comprises:
obtaining recorded information in the interaction list, wherein the recorded information contains other candidate multimedia services and other associated client identifications selected respectively by other audience clients that access the live broadcast room based on the multimedia service list; and
presenting the recorded information, and recording, according to a received instruction, a selected candidate multimedia service and an associated client identification in the interaction list.

8. The method according to claim 6, further comprising:
in response to the host client not selecting the candidate multimedia service and the associated client identification as the target multimedia service and the target client identification, obtaining and playing, in the live broadcast room, a video data stream for an operation interface of another target multimedia service, wherein
the video data stream is pushed by the live broadcast room;
the video data stream contains an interaction content between the host client and other audience clients in the operation interface of the other target multimedia service; and
the video data stream is obtained in real time through a replay pipeline service from a multimedia service server carrying the other target multimedia service, and is pushed in real time in the live broadcast room by using a cloud live streamer technology.

9. The method according to claim 7, further comprising:
in response to the host client not selecting the candidate multimedia service and the associated client identification as the target multimedia service and the target client identification, obtaining and playing, in the live broadcast room, a video data stream for an operation interface of another target multimedia service, wherein
the video data stream is pushed by the live broadcast room;
the video data stream contains an interaction content between the host client and other audience clients in the operation interface of the other target multimedia service; and
the video data stream is obtained in real time through a replay pipeline service from a multimedia service server carrying the other target multimedia service, and is pushed in real time in the live broadcast room by using a cloud live streamer technology.

10. The method according to claim 8, further comprising:
recording the other target multimedia service and an associated client identification in the interaction list, for requesting to access the operation interface of the other target multimedia service;
pushing an updated interaction list to the host client through the live broadcast room; and
in response to obtaining permission from the host client, accessing the operation interface of the other target multimedia service from the live broadcast room to interact with the host client.

11. A live broadcast method for a multimedia service, comprising:
in response to creating a live broadcast room, pushing a multimedia service list in the live broadcast room, wherein the multimedia service list at least records a service identification and a service access address of an interactive multimedia service;
generating and presenting an interaction list to a host client according to feedbacks from individual audience clients accessing the live broadcast room, wherein the interaction list records candidate multimedia services and associated client identifications selected respectively by the individual audience clients based on the multimedia service list; and
determining, based on an instruction from the host client, one candidate multimedia service and at least one associated client identification as a target multimedia service and a target client identification, respectively, and enabling, based on a service identification and a service access address of the target multimedia service, the host client and at least one audience client corresponding to the target client identification to access an operation interface of the target multimedia service from the live broadcast room, so that the host client interacts with the at least one audience client in the operation interface.

12. The method according to claim 11, further comprising:
obtaining in real time, through a replay pipeline service, a video data stream for the operation interface of the target multimedia service from a multimedia service server carrying the target multimedia service, wherein the video data stream contains interaction content between the host client and individual audience clients in the operation interface of the target multimedia service; and
pushing in real time, by using a cloud live streamer technology, the video data stream to other audience clients that access the live broadcast room.

13. The method according to claim 11, further comprising:
receiving a video data stream switching request sent by other audience clients, wherein the video data stream switching request carries identification information of a target object; and
re-pushing, based on the identification information, a corresponding video data stream to the other audience clients according to a viewing angle of the target object.

14. The method according to claim 12, further comprising:
receiving a video data stream switching request sent by other audience clients, wherein the video data stream switching request carries identification information of a target object; and
re-pushing, based on the identification information, a corresponding video data stream to the other audience clients according to a viewing angle of the target object.
